(19) United States
(12) Patent Application Publication
(10) Pub. No.: US 2010/0051195 A1
(43) Pub. Date: Mar. 4, 2010

(54) METHOD AND LAMINATING PRESS FOR LAMINATING WORK PIECES

(75) Inventor: Norbert Damm, Karlsdorf-Neuthard (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 12/540,737

(22) Filed: Aug. 13, 2009

(30) Foreign Application Priority Data
Aug. 28, 2008 (DE) 102008044862.1

(51) Int. Cl. B32B 37/10

(52) U.S. Cl. 156/285; 156/382

(57) ABSTRACT

A method and a laminating press for laminating work pieces which have at least one adhesive layer that can be activated by heat, under the effects of pressure and heat. Here, at least one work piece is introduced into an open press chamber of a laminating press that can be closed in an air-tight fashion. The press includes an upper chamber half and a lower chamber half. They are movable in reference to each other in order to open and close the press chamber, and a circumferential gasket is arranged between the upper and the lower chamber half. A membrane is mounted directly or indirectly at the upper chamber half and divides the press chamber in an air-tight fashion, and a heater is located to heat the work piece. Together with the work piece a separating film covering it against the membrane is introduced into the press chamber of the laminating press, the press chamber is closed, at least the volume of the press chamber located underneath the membrane and surrounding the work piece is evacuated, and the work piece is impinged with heat. Here, separating film is relaxed prior to closing the press chamber.

### CROSS-REFERENCE TO RELATED APPLICATIONS

This application claims the benefit of German Application No. DE 10 2008 044 862.1, filed Aug. 28, 2008, which is incorporated herein by reference as if fully set forth.

### BACKGROUND

The invention relates to a method for laminating work pieces, comprising at least one adhesive layer that can be activated by heat, under the effects of pressure and heat, as well as a laminating press for executing the method.

Here, a laminating press of the present type used in a method of the present type comprises at least one press chamber that can be closed in an air-tight fashion, having an upper chamber half and a lower chamber half, which are mobile in reference to each other, in order to allow opening and closing the press chamber. A circumferential gasket, comprising one or more parts, is arranged between the upper and the lower chamber half in order to allow an air-tight closing of the press chamber. A membrane is directly or indirectly arranged at the upper chamber half, dividing the press chamber in an air-tight fashion such that the press chamber is divided into a product space located between the lower chamber half and the membrane as well as a pressure space located between the membrane and the upper chamber half, as soon as the press chamber is closed. At least the lower chamber half is provided with means for evacuating the closed press chamber so that in any case the product space underneath the membrane can be evacuated.

Here, it must be mentioned that, in the sense of the present invention, it is not mandatory to use an elastic membrane. Rather, non-elastic materials may also be used for the membrane, i.e. diaphragm materials that are not tensile-elastic or of high tensile strength. It is merely important that the membrane divides the press chamber in an air-tight fashion.

In order to introduce the processing heat into the work piece, necessary for laminating work pieces, the laminating press comprises means for introducing heat into the work piece, with this means usually comprises hot plates forming a part of the lower and/or the upper chamber half.

In order to laminate a work piece, or usually simultaneously several work pieces, in the following for reasons of simplification only one work piece is being discussed, the work piece is inserted into the product space of the press chamber and the press chamber is closed. At this time the work piece shall be heated as little as possible. Because the heating of the work piece up to or above the refractory deformation temperature of the adhesive layer or layers contained therein, here again for reasons of clarification only one adhesive layer is being discussed, shall occur under a vacuum in order to remove any potential air pockets or gases developing from the work piece during heating, before the curing and/or interlacing of the adhesive begins in the adhesive layer. Air pockets or gas bubbles can cause leakages in the finished laminated work piece and must be therefore be prevented.

In order to adhere to these framework conditions usually the pressure space of the press chamber is first evacuated in order to pull the membrane upwards to the upper chamber half. Then, usually with a certain time delay, after the press chamber has been closed the product space is also evacuated, with the evacuation of the two spaces of the press chamber being regulated such that a pressure difference between the pressure space and the product space is upheld at all times, holding the membrane at the upper chamber half and preventing that the membrane can contact the work piece ahead of schedule.

When the product space of the press chamber has been evacuated to a predetermined pressure level, which usually amounts to less than 1 mbar, the pressure space is ventilated to such an extent that the pressure difference between the pressure space and the product space reverses and the membrane contacts the work piece. The compression of the membrane is adjusted by controlling the pressure in the pressure space. The pressure applied upon the work piece by the membrane then ensures, together with the introduction of the processing heat into the work piece, the softening and/or activation of the adhesive layer and, if applicable, its curing.

The preferred field of application of the present invention is the lamination of photo-voltaic modules, in which a layer of solar cells is encapsulated together with its electric contact elements in a moisture-sealed as well as weather-resistant and yet light-permeable fashion.

Such a laminating press is known from WO 2006/128699 A2, for example. Here, additionally a separating film is used, covering the work piece upwards from the membrane, and the separating film can optionally be inserted into the opened press chamber together with the work piece. This separating film prevents the very strong adhesive, commonly used in photo-voltaic modules, from contacting the membrane and thus contaminating it and thereby restricts its usability for excellent processing results or even renders it useless.

During the closing of the press chamber such a separating film is clamped tightly between the upper chamber half and the lower chamber half. Due to the fact that in most cases the separating line between the upper chamber half and the lower chamber half is not located precisely at the level of the upper limiting surface of the work piece but lower, the separating film is temporarily deflected over the work piece, beginning at its clamping positions between the upper and the lower chamber half, which results in a longitudinal tension within the separating film. This leads to increased stress at the edges of the work piece over which the separating film is being deflected.

The extent of this effect is multiplied when the work piece is lifted after the closing of the press chamber. Such a measure is common in laminating presses of the present type, because usually the processing heat is introduced into the press chamber via a hot plate integrated in the lower chamber half, and the work piece, as already explained at the outset, is to be heated as little as possible as long as the product space underneath the membrane is being evacuated. This lifting of the work piece in a closed press chamber, and accordingly also the separating film that is clamped tightly, strongly increases the stress upon the edges of the work piece.

### SUMMARY

The present invention is therefore based on the objective of providing a method and a laminating press for laminating work pieces of the type mentioned at the outset improved with regard to the mechanic stress of the work pieces to be laminated.

This objective is attained in a method according to the invention, as well as a laminating press having the features of the invention. Preferred further embodiments of the method and laminating press according to the invention are described below.

According to the invention, it has been recognized that the mechanical stress of the edges of the work pieces, at least the exterior edges of the work pieces when several work pieces are laminated simultaneously in the press chamber, is responsible for a multitude of faulty lamination results and malfunctions.

During the operation of laminating presses of prior art product defects occur relatively frequently, which either lead to a compromised quality of the product or even to total waste. In the case of photo-voltaic modules this frequently represents broken glass, which not only leads to a loss of the respective module but, due to the necessary cleaning expense for removing glass shards, to additional loss of production. Also, broken glass bears the risk of additional damages, for example a damaged membrane.

Even if no broken glass develops, product defects can occur, for example by way of individual layers of the work piece, which are to be laminated together, being displaced in reference to each other when the adhesive layer is softened.

The deflection of the already mentioned separating film, clamped tightly between the two chamber halves of the press chamber at the outer upper edges of the work piece or the work pieces, not only leads to flexural stress at these point but also to considerable lateral forces. According to the invention it has been recognized that these torques and lateral forces are the cause for the product defects and the broken glass already mentioned.

Within the scope of the present invention it is therefore suggested to relax the separating film prior to closing the press chamber and, to the extent the work piece shall be lifted for the duration of the evacuation of the product space in the press chamber, the work piece shall already be lifted before the press chamber is closed in an air-tight fashion, thus at a time the separating film has not been clamped tightly between the two chamber halves. This measure achieves that the separating film, usually pre-stressed to avoid the formation of folds, is relaxed and contacts the work piece without any elongation when the press chamber is closed and the separating film is being clamped tightly.

If the work piece is lifted in the press chamber the separating film is preferably relaxed prior to or during the lifting of the work piece. This way the formation of folds on the work piece is avoided. In any case it is advantageous for the separating film to be relaxed shortly before the press chamber is sealed in an entirely air-tight fashion, i.e. preferably the press chamber is first almost closed, subsequently the separating film is relaxed, and then the press chamber is sealed in an entirely air-tight fashion. This measure then ensures that the separating film contacts the work piece without any folds, however only a small distance remains to be traveled when the press chamber is closed and the elongation of the separating film is therefore also of a minor extent in order to avoid any stress upon the edges of the work pieces.

Preferably the work piece is inserted into the press chamber via a conveyer belt, traveling through the press chamber and essentially moving in a manner synchronized with the separating film, and also removed therefrom.

The relaxation of the separating film can occur by a motion of the guidance elements of the separating film, particularly by deflecting rolls or by the drive of the separating film.

### BRIEF DESCRIPTION OF THE DRAWINGS

An exemplary embodiment for a laminating press embodied according to the invention is described using the attached drawings, and the progression of a conventional method according to prior art is explained showing the respective problem recognized according to the invention. Shown are:

FIG. 1 is a schematic, lateral cross-section of a laminating press according to the invention;

FIG. 2 a view similar to FIG. 1, however of a laminating press according to prior art, in a first processing state;

FIG. 3 the laminating press of FIG. 2 in a second processing state;

FIG. 4 the laminating press of FIG. 2 in a third processing state.

### DETAILED DESCRIPTION OF THE PREFERRED EMBODIMENTS

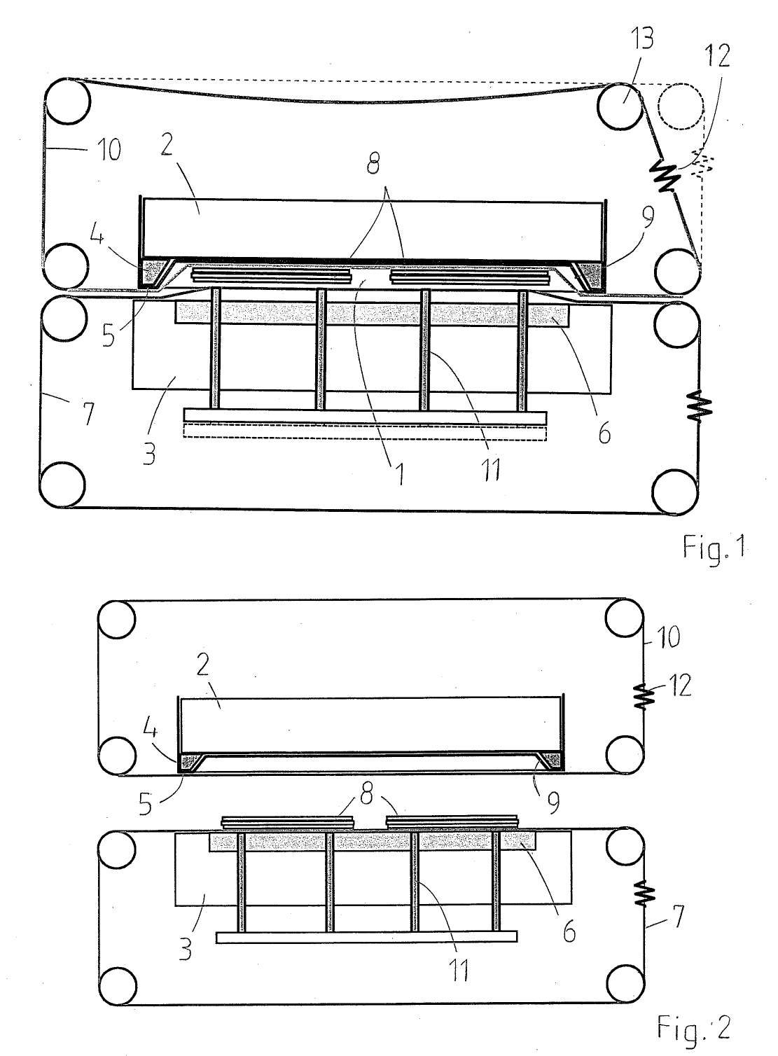

The device shown in a schematic lateral cross-section depicted in FIG. 1 comprises a press chamber 1 with an upper chamber half 2 and a lower chamber half 3 as well as sealing frame 4 mounted at the upper chamber half 2 having a circumferential gasket 5. The upper chamber half 2 can be moved up and down in order to allow opening and closing the press chamber. The lower chamber half 3 is provided with a hot plate 6 in order to allow introducing the necessary processing heat into the press chamber 1. Work pieces 8 are inserted into the press chamber 1 on a revolving conveyer belt 7 and are also removed therefrom. In the present exemplary embodiment, these work pieces 8 represent photo-voltaic modules comprising a glass plate, a layer of solar cells embedded in an adhesive layer, and a rear film. These layers shall be laminated to each other in the present device under the effects of pressure and heat.

A flexible membrane 9 is provided at the upper chamber half 2, which in the processing state shown has been pulled close to the upper chamber half 2 by evacuating the space located above the membrane 9. The membrane 9 divides the press chamber 1 in an air-tight fashion over its entire surface. In order to protect said membrane 9, a separating film 10 is inserted simultaneously with the work pieces 8 via the conveyer belt 7 into the press chamber 1 and also removed therefrom. The separating film 10 is positioned between the work pieces 8 and the membrane 9 and accordingly protects the membrane 9 from adhesive potentially exiting the work pieces 8. A spring 12 stretches the separating film 10 in a planar fashion in order to avoid the formation of folds during its transportation through the press chamber 1.

A lifting device 11 is provided in the lower chamber half 3, allowing the lifting of the work pieces 8 off the hot plate 6 inserted in the lower chamber half 3. The lifting prevents the work pieces 8 from being impinged ahead of schedule with heat from the hot plate 6.

The above-described parts of the devices embodied according to the invention shown in FIG. 1 are equivalent to a device according to prior art, as illustrated in FIGS. 2, 3, and 4. Equivalent parts are therefore marked with the same reference characters in all figures. Using FIGS. 2 through 4, now the processing steps according to prior art shall be described.

The loading of the open press chamber 1 with work pieces 8, shown in FIG. 2, occurs with the lifting device 11 being lowered. This is necessary because otherwise the conveyer belt 7 had to be pulled over the lifting device 11 and could damage the front edges of the work pieces 8 by bumping against the lifting device 11.

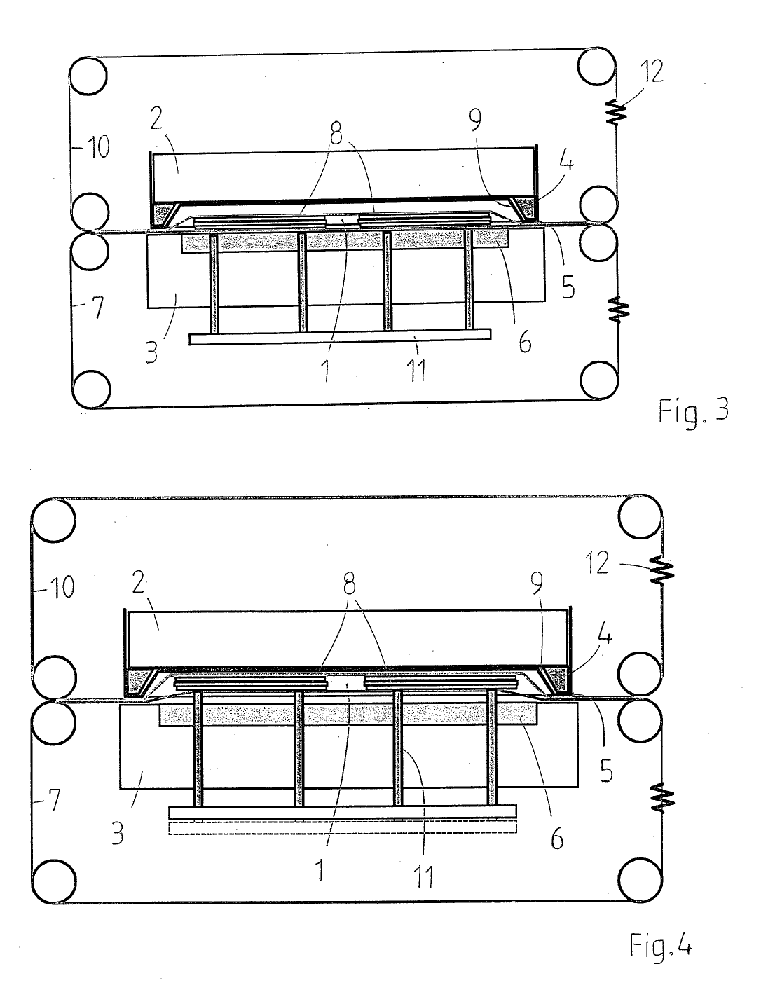

As discernible from FIG. 3, then the press chamber 1 is closed in prior art by lowering the upper chamber half 2 onto the lower chamber half 3. Due to the need for sealing the press chamber 1 in an air-tight fashion here both the conveyer belt 7 as well as the separating film 10 are clamped tightly in an immobile, fixed manner at the gasket 5 between the upper chamber half 2 and/or the sealing frame 4 mounted thereat and the lower chamber half 3. Since the separating film 10 is clamped via a spring 12 to remain free from folds it is stressed upwards as early as the time of clamping by the work pieces 8 positioned elevated on the conveyer belt 7. Here, the edges of the work pieces positioned at the outside in the direction of travel are impinged with a force component arising from the tensile force of the separating film 10. This tensile force impinges the lateral edges of the exterior work pieces 8 from the outside towards the inside longitudinally in reference to the direction of travel. The closer the work pieces 8 are positioned in reference to the sealing frame 4 of the press chamber 1 the stronger and more acutely the affects of the force component resulting here.

As discernible from FIG. 4, the lifting device 11 is activated in prior art immediately after the press chamber 1 has been closed in order to lift the work pieces 8 off the hot plate 6. The purpose of this measure is to avoid any undesired strong heating of the adhesive layers in the work pieces 8 ahead of schedule. Usually a lift of 12 to 15 mm is performed, here.

During the lifting of the work pieces 8 the stretched separating film 10 is further stressed. At common distances of the edges of the exterior work pieces 8 from the sealing frame 4, amounting from approx. 50 to 80 mm, a considerable bending moment develops, and consequently a high bending stress as well as lateral forces act upon the work pieces 8, which can actually lead to breaking glass. Here, the spring 12 cannot provide any compensation because the separating film 10 is clamped at the edges in the press chamber closed in an air-tight fashion.

Returning to FIG. 1, the measures according to the invention for solving the problems recognized according to the invention can be described:

As discernible in FIG. 1, first the sequence of the steps of the process is modified. The lifting of the work pieces 8 off the hot plate 6 by the lifting device 11 occurs early, at a time when the press chamber 1 has not been completely closed. At this time the separating film 10 has not been clamped tightly at the edges. The upward motion of the work pieces 8 pulls the separating film 10, not clamped, over the gasket 5. The tensile force necessary here is very small because the separating film 10 is of low friction due to its anti-adhesive function, and the tension of the spring 12 has previously been relaxed. Subsequently the separating film 10 is placed without any longitudinal tension over the work pieces 8 lifted off the hot plate 6. The remaining minimal closing lift of the upper chamber half 2 following cannot create any longitudinal tension in the separating film; the work pieces 8 are positioned without any stress on the lifting device 11.

As an additional measure according to the invention, it is provided and illustrated in FIG. 1 to move a deflecting station 13 perpendicular in reference to the deflection axis for deflecting and guiding the rotating separating film 10 in order to allow an active relaxation of the separating film 10. This compensates and/or overcompensates particularly the spring force 12, which ensures a placement of the separating film 10 without any folds during the introduction of the work pieces 8 so that in any case the separating film 10 can be placed upon the work pieces 8 in a relaxed state and thus the work pieces 8 are not stressed.

In a non-rotational embodiment of the separating film 10 an active relaxation thereof can occur, for example, by a slight reverse motion of the tensile elements for the sections of the separating film.

1. A method for laminating work pieces, comprising at least one adhesive layer that can be activated by heat, under the effects of pressure and heat, comprising the processing steps:
introducing at least one work piece (8) into a open press chamber (1) of a laminating press that can be closed in an air-tight fashion, having an upper chamber half (2) and a lower chamber half (3) that can be moved in reference to each other in order to open the press chamber (1) or to close it, having a circumferential gasket (5), comprising one or more parts, arranged between the upper and the lower chamber halves (2, 3), having a membrane (9) arranged directly or indirectly at the upper chamber half (2) dividing the press chamber (1) in an air-tight fashion, as well as a heater (6) to introduce heat into the work piece (8),
introducing a separating film (10) covering the work piece (8) upwards against the membrane (9) in the press chamber (1) of the laminating press,
relaxing the separating film (10) prior to closing the press chamber (1)
closing the press chamber (1),
evacuating at least a volume of the press chamber (1) located underneath the membrane (9) and surrounding the work piece (8), and
impinging the work piece (8) with heat.

2. The method according to claim 1, further comprising lifting the work piece (8) prior to the press chamber (1) being closed in an air-tight fashion.

3. The method according to claim 2, further comprising relaxing the separating film (10) prior to or during lifting of the work piece (8).

4. The method according to claim 1, wherein when the press chamber (1) is almost closed, the separating film (10) is subsequently relaxed, and then the press chamber (1) is closed completely in an air-tight fashion.

5. The method according to claim 1, further wherein the introducing of the work piece (8) into the press chamber (1) occurs via a conveyer belt (7) traveling through the press chamber (1) and moving essentially synchronized with the separating film (10).

6. The method according to claim 1, further comprising holding the separating film (10) in a planar stretched fashion during the introduction into the press chamber (1) in order to avoid forming any folds.

7. The method according to claim 1, wherein the relaxation of the separating film (10) occurs via a motion of guiding elements (13) of the separating film.

8. A laminating press for laminating work pieces, comprising at least one adhesive layer that can be activated by heat, under the effects of pressure and heat, the laminating press comprising at least one press chamber (1) that can be closed in an air-tight fashion having an upper chamber half (2) and a lower chamber half (3), which can be moved in reference to each other in order to open or close the press chamber (1), a gasket (5) comprising one or more parts arranged between the upper and the lower chamber half (2, 3), a membrane (9) arranged directly or indirectly at the upper chamber half (2), dividing the press chamber (1) in an air-tight fashion, as well as a heater (6) for introducing heat into the work piece, with at least the lower chamber half (3) being provided with a vacuum connection to evacuate the closed press chamber (1), and at least one separating film (10) being provided that can be introduced into the press chamber (1) in an open state and cover the work piece (8) upwards against the membrane (9), and a deflecting device (13) that relaxes the separating film (10).

9. The laminating press according to claim 8, wherein the deflecting device for relaxing the separating film (10) is coupled with guidance elements for the separating film (10).

10. The laminating press according to claim 9, wherein the guidance elements are embodied as the deflecting device (13) or as a tensioning device for the separating film (10).

11. The laminating press according to claim 10, wherein the deflecting device (13) for the separating film (10) can be moved perpendicular in reference to a deflection axis.

12. The laminating press according to claim 8, wherein a tensioning device (12) for the separating film (10) is provided to avoid the formation of any folds.

13. The laminating press according to claim 8, further comprising a conveyer belt (7) that travels through the press chamber (1), that can essentially move synchronized with the separating film.

14. The laminating press according to claim 8, further comprising a lift (11) that raises the work piece (8) in reference to the lower chamber half (3).
